(19) United States
(12) Patent Application Publication
(10) Pub. No.: US 2018/0130134 A1
(43) Pub. Date: May 10, 2018

(54) SYSTEM AND METHOD FOR SELECTING PORTFOLIO MANAGERS

(71) Applicant: Fiduciary Investment Solutions, Inc., Philadelphia, PA (US)

(72) Inventor: Tina S. Byles Williams, Columbus, OH (US)

(21) Appl. No.: 15/861,806

(22) Filed: Jan. 4, 2018

Related U.S. Application Data
(63) Continuation-in-part of application No. 15/152,881, filed on May 12, 2016, now abandoned.
Application No. 15/152,881 is a continuation-in-part of application No. 15/071,603, filed on Mar. 16, 2016, now abandoned.

(51) Int. Cl. G06Q 40/06

(52) U.S. Cl. CPC G06Q 40/06

(57) ABSTRACT

Disclosed are a system and a method for selecting index Portfolio Managers/Products and active Portfolio Managers/Products for an investment portfolio. The invention separates the performance impact of temporal market events from a Portfolio Manager's active security and/or factor selection skill. The method includes preparing data by calculating excess returns for Portfolio Managers/Products using stock market indices, extracting Active Share, and extracting raw factor data and generating composite indices for sectors. Using the skill metrics, Active Shares, and Manager 36-month return, a cross sectional rolling regression model with rolling one-month window is calibrated to forecast the probability of outperforming a benchmark over the subsequent 36-month period. To determine the efficacy of each of the forecast models, an analysis is performed to determine the overall accuracy for each one. P-values are used to measure significance of the independent variables. Accuracy is measured by comparing forecasts with Managers' actual excess returns.

### CROSS REFERENCE TO RELATED APPLICATIONS

This application is a continuation-in-part of U.S. patent application Ser. No. 15/152,881, filed May 12, 2016, which is a continuation-in-part of U.S. patent application Ser. No. 15/071,603, filed Mar. 16, 2016; the entire disclosures of these applications are incorporated herein by reference.

### FIELD

The present invention generally relates to investment portfolios. More particularly, the present invention is directed to a system and method for selecting investment managers and products for both separately managed and pooled investment accounts (hereinafter referred to collectively as “Portfolio Managers/Products”) that are likely to outperform the market benchmark relative to their investment style using real-world data.

### BACKGROUND

Investors hire portfolio managers to act as their agents, and portfolio managers are trusted to perform to the best of their abilities and in the investors' best interests. Portfolio manager selection is a critical step in implementing any investment program. In most cases, investors choose portfolio managers to determine the most appropriate product(s) in which to place assets. Investors want portfolio managers who are highly skilled, diligent, and persistent; and they also want portfolio managers whose interests are aligned with their own. Investors must practice due diligence when selecting index Portfolio Managers/Products or active Portfolio Managers/Products.

Selecting Portfolio Managers is a complicated and difficult process, however. Portfolio Manager/Product performance varies over time, and such performance is driven by factors that are both controllable by and outside the control of Portfolio Managers. Thus, a Portfolio Manager's skill in actively selecting securities is often conflated with the performance impact of temporal market and other factors associated with market cycles that passively favor or disfavor the Portfolio Manager's particular investment approach. In other words, active security or factor selection skill is often conflated with luck. The invention described herein addresses these problems by identifying factor exposures and disaggregating the effects of factors from stock selection given a measure of a manager's excess return to forecast managers who have a non-random possibility of generating positive excess return over a three-year market cycle period, post-selection.

One of the existing methods by which investors select Portfolio Managers/Products is by analyzing their prior performance to evaluate the possibility of future performance relative to that of the market index applicable to the Portfolio Manager's investment style, (commonly referred to as benchmark relative “excess return” and/or “alpha”). For such evaluations, common units of evaluations include historical returns over various trailing periods, risk-adjusted return measures (such as the Sharpe Ratio and/or Information Ratio) over various trailing periods and/or Morningstar ratings for registered funds. Additionally, after a Portfolio Manager/Product has been retained, investors commonly evaluate performance on the basis of the above referenced comparisons.

However, several studies have demonstrated that these selection criteria have limited accuracy in predicting future peer relative out-performance and are subject to substantial performance degradation over the three to five-year contractual term for which investment managers are typically retained. The invention described herein addresses these problems by using forecasting methods to improve the accuracy with which investors can select Portfolio Managers/Products that are likely to outperform and yield a positive return.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

Some embodiments of the present invention include devices, systems, and methods of automatically forecasting managers that will outperform their style benchmark over a three-year market cycle, post selection.

Some embodiments of the present system comprise a memory unit having stored thereon instructions, and a processor to execute the instructions to perform operations, namely, to forecast Portfolio Managers/Products that are most likely to outperform the market benchmark relevant to their investment style or process.

Some embodiments of the present method include preparing data. In one embodiment, the method begins with using subsets of listed funds from the Petajisto (2013) dataset that are benchmarked against the Russell 1000 Index as well as registered mutual funds classified by Morningstar, Inc. (hereinafter referred to as “Morningstar”) in the broad equity universe. It is noted that various types of commercial database or proprietary input data may be used regarding Portfolio Manager/Products. In order to test the methodology for Small Capitalization U.S. and Non-U.S. equity stock funds, the present method uses subsets of the mutual funds that benchmark themselves to the Russell 2000, S&P 600 and MSCI EAFE index, respectively. The method also includes evaluating the performance of stocks of different factor and industry groups for various categories of investment management styles within the broad public equity stock universe.

The present method further includes extracting market index and fund returns, as well as Active Share (AS) data for each fund or product from the Petajisto and Morningstar fund universe datasets; and calculating various performance measures including excess return and a modified measure of return consistency or batting average. The method also includes extracting raw factor data for factors and industries from Barra; and generating composite indices for sectors using Barra. The present method further includes identifying factor exposures and disaggregating the effects of factors from stock selection given a measure of a manager's excess return in order to determine managers' skills and choosing one or more managers for given portfolios. The method further includes segmenting managers' excess returns into overall excess return, factor “clone” excess return, and stock selection excess return.

The first step of the present method or operation can also be implemented using other factor exposure databases such as FactSet, Axioma or Bloomberg, as well as other Portfolio Manager databases such as Evestment, FactSet or an end user's proprietary Portfolio Manager database.

The second step of the method includes generating several analytical inputs using skill score measures. Skill scores are measured at the total excess return level, factor excess return level, and stock selection excess return level using a rolling window period of 36 months. Each manager's three-year forward rolling excess return are measured.

Using the skill metrics, Active Shares, and a manager's 36-month excess return over time, a cross sectional rolling regression model with rolling window of one month is calibrated using a variety of combination of inputs to forecast the probability of outperforming benchmark by certain magnitude over the subsequent 36 month period. To determine the efficacy of each of the forecast models, an analysis is performed to determine the overall accuracy for each one. P-values are used to measure significance of the independent variables. Accuracy is measured by comparing forecasts with managers' actual excess returns. If both forecast and actual excess return are above or below a certain threshold, the forecast is correct. If forecast is above the threshold but actual excess return is below the threshold or vice versa, the forecast is incorrect.

It is therefore an objective of the present invention to provide a system that can make determinations of Portfolio Manager skill across various dimensions apart from the impact of temporal market factors and other factors that passively favor or disfavor a Portfolio Manager's particular investment approach.

It is another objective of the present invention to use an assessment of a Portfolio Manager's skill (as compared to the influence of luck) to determine whether a Portfolio Manager/Product is suitable for inclusion in a particular portfolio.

In accordance with one aspect of the disclosed subject matter, for example, a method may generally comprise: calculating an overall excess return generated by a Portfolio Manager, wherein the overall excess return represents a return on investment in excess of index return data and wherein the index return data are available from a public source; segmenting the overall excess return by calculating a factor clone excess return and a stock selection excess return, wherein the factor clone excess return represents a contribution of temporal market events and wherein the stock selection excess return represents a contribution of the Portfolio Manager's investment strategy; calculating a respective skill score associated with each of the overall excess return, the factor clone excess return, and the stock selection excess return; and generating a forecast model based on the respective skill scores, whereby the forecast model disaggregates effects of the investment strategy and the temporal market events, and wherein the forecast model represents the Portfolio Manager's probability of exceeding a market benchmark rate of return.

In some implementations, such a method may further comprise identifying Active Share data for a financial product, wherein the Active Share data are available from a public source, and wherein the generating a forecast model comprises utilizing a cross sectional rolling regression model comprising the respective skill scores, the Active Share data, and a monthly overall excess return computed for the Portfolio Manager over a period of time, wherein the respective skill scores are converted to a z-score using an inverse normal distribution such that the z-score is directly proportional to the investment strategy rather than the temporal market events. It will be appreciated that the overall excess return may be calculated against a stock market index. The disclosed methods may further comprise, when a gap in the Active Share data is identified, smoothing sequential measures of the Active Share data using a respective data point from each side of the gap.

In some instances, the respective skill scores may be derived from historical monthly data for a given period of time, and the overall excess return may include factors associated with forward benchmark relative excess return for the given period of time and edge measures.

The method may further comprise comparing the forecast model with true benchmark relative excess return. Additionally, in such an embodiment, the method may further comprise: assigning a forecast accuracy value to the forecast model wherein the forecast accuracy value is computed using the true benchmark relative excess return; and comparing the forecast accuracy value with a different forecast accuracy value assigned to a different forecast model generated based upon a different market benchmark rate of return.

In accordance with some embodiments, a method may generally comprise: generating a first forecast model to predict a Portfolio Manager's first probability of exceeding a first market benchmark rate of return, the first probability based on a first overall excess return comprising a first investment strategy component and a temporal market events component, whereby the first forecast model disaggregates effects of the first investment strategy component and the temporal market events component; generating a second forecast model to predict the Portfolio Manager's second probability of exceeding a second market benchmark rate of return, the second probability based on a second overall excess return comprising a second investment strategy component and the temporal market events component, whereby the second forecast model disaggregates effects of the second investment strategy component and the temporal market events component; and assigning a first forecast accuracy value and a second forecast accuracy value to the first forecast model and the second forecast model, respectively, and comparing the first investment strategy to the second investment strategy responsive to said assigning.

In some implementations of the method, the assigning comprises computing the first forecast accuracy value and the second forecast accuracy value using a first true benchmark relative excess return and a second true benchmark relative return, respectively.

In the light of the foregoing, these and other objectives are accomplished through the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 depicts an exemplary embodiment of a data processing device through which the present method can be implemented.

FIG. 2 depicts exemplary model accuracy tables for Russell 1000 and Russell 2000.

FIGS. 3A and 3B show exemplary flowcharts of the present method.

### DETAILED DESCRIPTION

The present invention is directed towards a system and method for selecting Portfolio Managers/Products. For purposes of clarity, and not by way of limitation, illustrative views of the present system and method are described with references made to the above-identified figures. Various modifications obvious to one skilled in the art are deemed to be within the spirit and scope of the present invention.

As used in this application, the terms “component,” “module,” “system,” “interface,” or the like are generally intended to refer to a computer-related entity, either hardware or a combination of hardware and software. For example, a component can be, but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

It is to be appreciated that determinations or inferences referenced throughout the subject specification can be practiced through the use of artificial intelligence techniques. In this regard, some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Discussions herein utilizing terms such as, for example, “processing,” “computing,” “calculating,” “determining,” “establishing,” “identifying,” “analyzing,” “checking,” or the like, may refer to operations(s) and/or process(es) of a computer, a computing platform, a computing system, or other electronic computing device, that manipulate and/or transfer data represented as physical (e.g., electronic) quantities within the computer's registers and/or memories into other data similarly represented as physical quantities within the computer's registers and/or memories or other information storage medium that may store instructions to perform operations and/or processes.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” or “at least one” unless specified otherwise or clear from context to be directed to a singular form. Furthermore, terms “customer” and “user” are used interchangeably, unless the context clearly indicates otherwise. Similarly, terms “Managers,” “Portfolio Managers,” “Products,” “Portfolio Managers/Products,” and other terms pertaining to suitable financial service tools or instruments may be used interchangeably, unless the context clearly indicates otherwise.

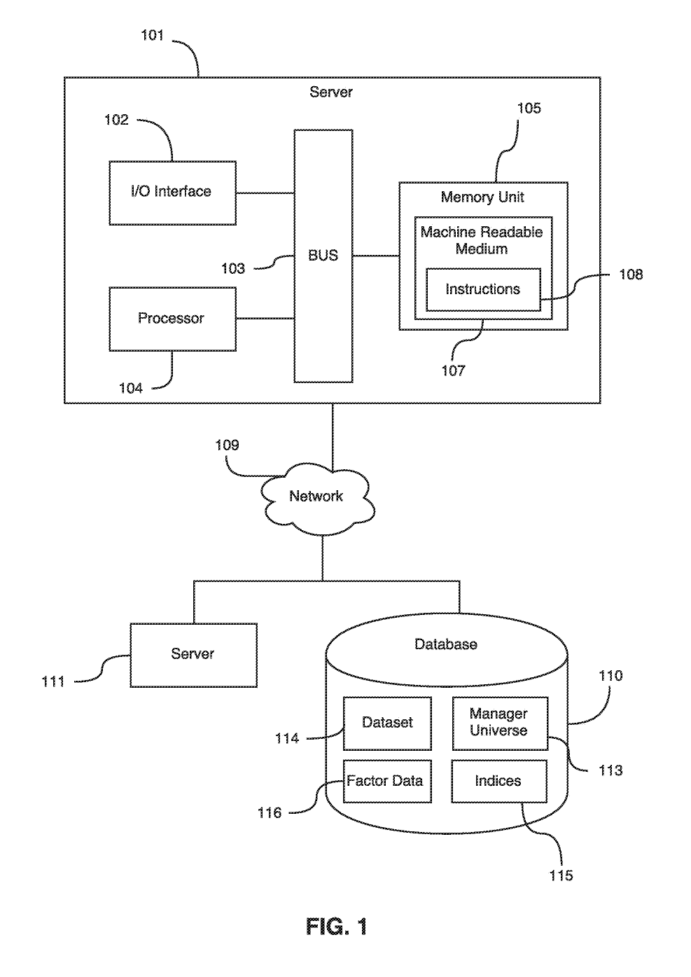

Referring now to FIG. 1, there is shown exemplary block diagrams of the present system. The present system comprises at least one server device 101. The server device 101 comprises various types of computer systems and similar data processing device, such as a desktop computer, laptop, handheld computing device, a mobile device, tablet computer, a personal digital assistant (PDA), and the like. The device 101 can operate as a standalone device or may be connected to third party devices 111 via a network 109 (e.g., the Internet, LAN, WLAN). Without limitation, the third party devices 111 comprise servers, including on-site servers and cloud-based servers. In a networked embodiment, the device 101 can operate in the capacity of a server or a client machine in a server-client network environment, or as a peer machine in a peer-to-peer (or distributed) network environment.

The device 101 includes a processor 104 (e.g., a central processing unit), input/output (I/O) interface 102, and a non-transitory computer readable storage medium 107 in a memory unit 105 containing instructions 108, wherein these components communicate with each other via a BUS 103. Without limitation, I/O interface 102 comprises alphanumeric input devices (e.g., a keyboard), a navigation device (e.g., a mouse), speakers, cameras, microphones, and the like. It is noted that the device 101 may comprise additional components that are necessary for operating the device 101, depending upon embodiment. For example, the device 101 may further include a display unit (e.g., a touch screen), a disk drive unit, a signal generation device, a network interface device, an environmental input device, and sensors.

The processor 104 communicates with the memory unit 105 so as to access the instructions 108 stored thereon. The memory unit 105 comprises any non-transitory computer readable medium 107 on which is stored one or more sets of data structures and instructions 108 embodying or utilized by any one or more of the methodologies or functions described herein. Without limitation, the memory unit 105 may comprise a random access memory (RAM), read-only memory (ROM), a floppy disk, a compact disc, digital video device, a magnetic disk, an ASIC, a configured processor, or other storage device. Additionally, the device 101 may communicate with one or more remote databases 110 connected thereto. It is also noted that the instructions 108 may also reside, completely or at least partially, within a disk drive unit and/or within the processor 104, depending upon embodiment. In this regard, the disk drive unit and/or the processor 104 may also constitute machine-readable media.

The instructions 108 comprise executable code written in any suitable computer-programming language. In this regard, the instructions 108 may comprise a software application, a web application, a mobile application, and the like. It is contemplated that the software application, the web application, and/or the mobile application comprises a graphical user interface (GUI) component for receiving user input and outputting or displaying information. The instructions 108, when executed on the processor 104, cause the processor 104 to perform operations. The operations include generating and analyzing data to identify turning points in segment, factor, and Manager performance.

The first step of the operations primarily involves preparing data. The processor 104 is configured to prepare data using subsets of listed funds from the Petajisto (2013) dataset that are benchmarked against the Russell 1000 Index as well as registered mutual funds classified by Morningstar benchmarked against the Russell 2000, S&P 600 and MSCI EAFE indices. In this regard, device 101 of the processor 104 can communicate with the database 110 or another server to retrieve various types of datasets 114 stored therein, wherein the datasets comprise the Petajisto dataset, Morningstar dataset, and other benchmarks.

The processor 104 is also configured to evaluate the performance of stocks of different factor and industry groups for various categories of investment management styles within the broad public equity stock universe. The processor 104 also extracts Active Share data for the mutual funds incorporated in the Petajisto dataset (i.e., for domestic equity) and Morningstar dataset (i.e., for Non-U.S. equity) from the database 110, wherein the datasets 114 are computed separately each quarter when fund holdings are disclosed and then stored in the database 110. The benchmark index is the official benchmark index disclosed in the prospectus. The file also reports the benchmark index that produces the lowest Active Share. It is contemplated the datasets can also be stored and/or derived from third party databases and/or the servers 111, depending upon embodiment.

In the context of this disclosure, the term “Active Share” generally refers to a measure of the percentage of stock holdings in a Manager's portfolio that differ from a benchmark index. Those of skill in the art will appreciate that Active Share is calculated by taking the sum of the absolute value of the differences of the weight of each holding in a Manager's portfolio versus the weight of each holding in the benchmark index and dividing by two. Managers with high Active Share are generally understood to outperform the benchmark indexes, and those of skill in the art understand that Active Share tends to predict fund performance for a particular Manager.

It is noted, however, that the present invention is not intended to be limited to Portfolio Managers/Products that are benchmarked against the Russell 1000, Russell 2000, S&P 600 and MSCI EAFE indices only and/or the Petajisto or Morningstar datasets; any type of suitable indices and datasets may be utilized. Any group of public equity securities, including one developed by the user of the present method, could also be substituted for the aforementioned indices and datasets. Moreover, any data or information related to each index 115 or dataset 114 may be stored in one or more databases 110.

The processor 104 calculates Manager excess returns using a subset of the Petajisto universe as the base universe for Large Capitalization U.S. equity Managers and Morningstar mutual fund database for Small Capitalization U.S. equity Managers and Non-U.S. equity Managers. Manager excess returns are calculated against the Russell 1000 Index for Large Capitalization U.S. equity Managers, the Russell 2000 Index for Small Capitalization U.S. equity Managers, and the MSCI EAFE Index for Non-U.S. equity Managers. Manager excess returns and other data pertaining to Portfolio Managers are stored in a universe of Managers 113 within the database 110. Alternatively, the universe of Managers 113 can function as a standalone database. It is contemplated that the Manager excess returns and other data pertaining to Portfolio Managers may correspond to individual Portfolio Managers/Products, and can include any suitable Manager-specific profile information.

In the context of the present disclosure, the term “excess returns” is generally intended to refer to investment returns from a security or portfolio that exceed the riskless rate on a security generally perceived to be risk-free, such as a certificate of deposit or a government-issued bond, and generally indicate returns that exceed a particular benchmark or index with a similar level of risk. Specifically, the term “excess returns” is widely used as a measure of the value added by the Manager, or the Manager's ability to “beat” the market, as it is an indicum of what the Manager's investment strategy produces that is in “excess” of what could have been achieved via other similarly risky investment approaches.

The processor 104 is configured to extract raw factor data 116 for factors and industries from Barra using the FactSet Portfolio tools (SPAR/Portfolio Analytics); and generate composite indices 115 for sectors using Barra industry risk data, mapped to GICS Sectors, then combine the indices into a single index using a volatility-weighted approach. The processor 104 then segments the Managers' excess returns into overall excess return, factor “clone” excess return, and stock selection excess return.

The processor 104 is configured to generate several analytical inputs using skill score measure. Skill scores are measured on a pass-fail basis over a period of time. Positive excess return (i.e., pass) yields a value of 1, and a negative excess return (i.e., fail) yields a value of 0. In this regard, pass-fail basis is measured in a binary series of data. The processor 104 utilizes this data to measure the probability of outperformance given the total number of trials. The processor 104 then converts the cumulative probability to a z-score using an inverse normal distribution to measure the skill scores at the total excess return level, factor excess return level, and stock selection level. In one embodiment, a rolling window period of 36 months is used to generate and/or obtain sufficient amounts of data. The processor 104 is further configured to measure each Manager's three-year forward rolling excess return for analysis.

Using the skill metrics and Active Shares, along with a Manager's 36-month excess return over time, the processor 104 calibrates a cross sectional rolling regression model with rolling window of one month to forecast the probability of outperforming benchmark by certain magnitude or predetermined value over the subsequent 36 month period. This allows for identification of Portfolio Managers/Products that are most likely to outperform within the universe of their peers 113. In that regard, those of skill in the art will appreciate that the cumulative probability of outperformance over a specific period of time for a particular Manager generally changes over time, and that a forecast model may appropriately account for these changes (for example, based upon historical performance, present or prospective investment strategy, prevailing market conditions, or a combination of these and a variety of other factors) as time progresses. In one embodiment, a rolling regression model as set forth above may be suitable to predict probabilities of outperformance as new data become available that may affect those probabilities. In some instances, a rolling one month window may be appropriate, though other window durations are contemplated. Ror example, in relatively slow moving markets or industries, a longer window may provide better results, whereas in relatively volatile or fast moving markets or industries, a shorter window may result in more accurate forecasts. It is noted that the utility of such forecasts may depend, for example, on the sophistication of the regression model used, the accuracy of the input data, the number and characteristics of the variables employed, or a combination of these and a variety of other factors generally known in the art. The present disclosure is not intended to be limited by the particular architecture of any specific regression model or by the number or nature of the variables employed.

The processor 104 determines overall accuracy of each of the forecast models to determine the efficacy of the same. In this regard, the processor 104 utilizes P-values to measure significance of the independent variables. P-values are generated in order to gauge the significance of independent variables. For example, based on a 5% significance level, everything below the 5% cutoff line is considered significant and will add value to the forecast models. The processor 104 compares forecasts with a Manager's actual excess returns to measure accuracy. If both forecast and actual excess returns are above or below a predetermined threshold, the forecast is correct. If the forecast is above the threshold but actual is below the threshold or vice versa, the forecast is incorrect.

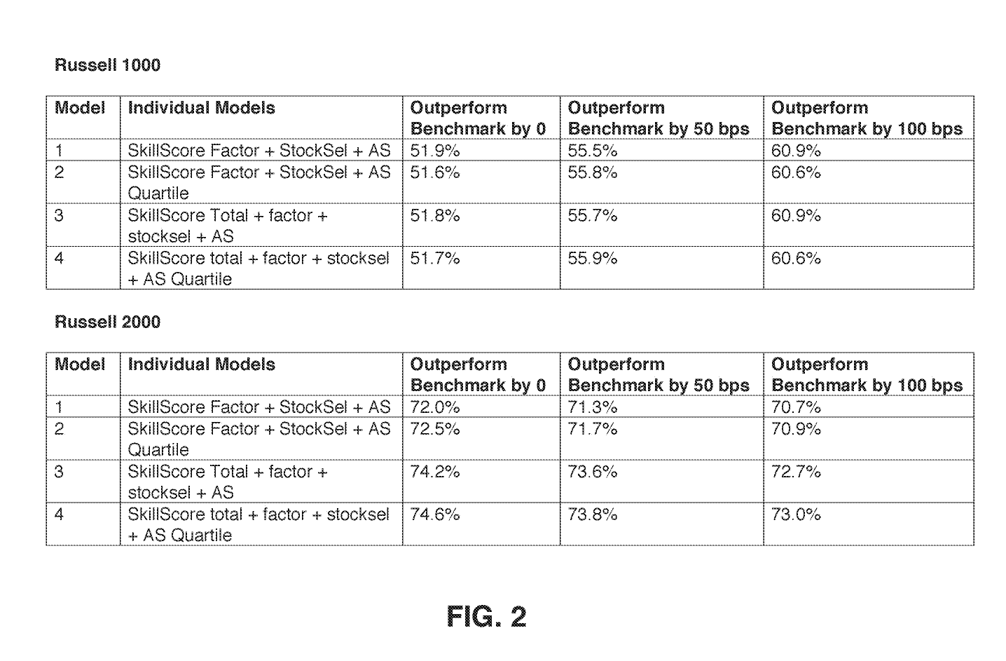

The processor 104 is configured to compare different individual models (e.g., raw Active Share, Active Share Quartile, and Skill Score (Total, Factor and Stock Selection) models, and any combination thereof) and select the model with the best forecast accuracy values as the final model for each benchmark (i.e., Russell 1000, Russell 2000, EAFE). Referring to the individual model accuracy tables for Russell 1000 and Russell 2000 shown in FIG. 2, for example, the processor 104 would select Model 4 for Russell 1000 and Model 4 for Russell 2000 because Model 4 for each benchmark has the best (i.e., greatest) forecast accuracy.

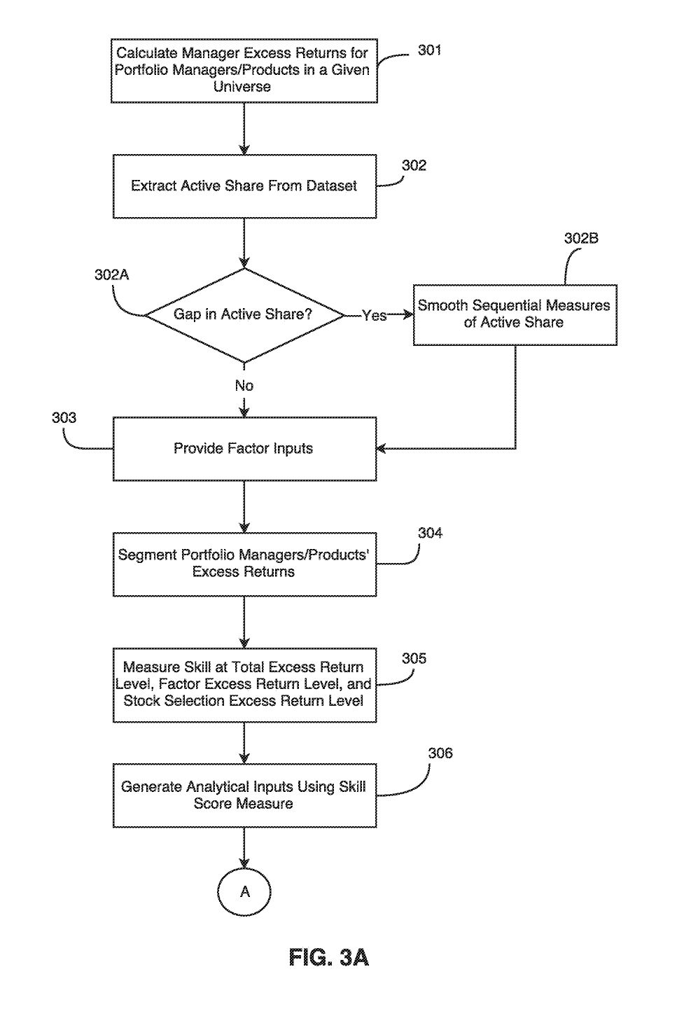

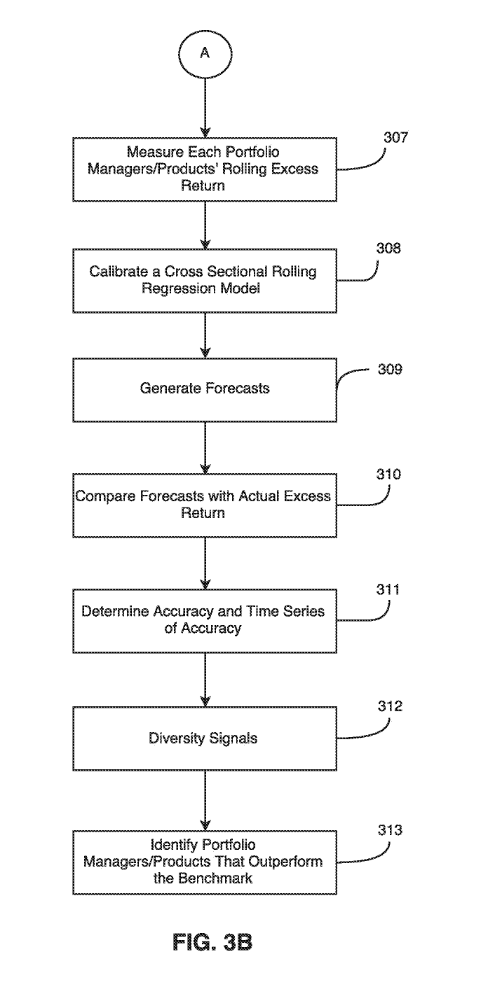

FIGS. 3A and 3B show an exemplary method of automatic determinations of Portfolio Manager skill across various dimensions apart from the impact of temporal market factors, among other factors. In some embodiments, one or more of the operations shown in FIGS. 3A and 3B may be performed by one or more elements of the system shown in FIG. 1, e.g., server 101 (FIG. 1). In the step indicated by the diagram block 301, Portfolio Manager/Product excess returns are calculated for a peer universe 113 (FIG. 1) using a subset of the Petajisto U.S. equity universe as the base universe for Large Capitalization U.S. equity Managers benchmarked to the Russell 1000 Index, the Morningstar mutual fund universe for the Small Capitalization U.S. equity Managers and Non-U.S. equity Managers. Additionally, Portfolio Manager/Product excess returns are calculated against the Russell 1000 Index for Large Capitalization U.S. equity Managers, the Russell 2000 Index for Small Capitalization U.S. equity Managers and the MSCI EAFE Index for Non-U.S. equity Managers.

For Non-U.S. equity Portfolio Managers/Products, an Oil Factor that was developed using the geometric mean of the spot price (first month future) for ICE Brent Crude Futures and the futures for one year forward in three-month increments (fourth month, seventh month, tenth month, and thirteenth month) are also included. This approach dampens some of the volatility associated with the spot price while still capturing the variability and incorporates information from the future curve. In other words, this approach reduces the weight of outliers while retaining the degree of variation exhibited in movements of the front end of the oil futures curve. To create the return series, the monthly percentage change in this mean price of oil is measured.

For Non-U.S. equity, an EM risk factor that is developed using the weighted average of EM country risk factors are also included. EM country weighting is extracted from FactSet using MSCI Emerging Markets Index and country risk factors are extracted from Barra GEM3 Model using the FactSet Portfolio tools (SPAR/Portfolio Analytics).

In the step indicated by the diagram block 302, Active Share is taken directly from either the Petajisto or Morningstar dataset, wherein, as noted above, Active Share is a measure of the percentage of stock holdings in a Portfolio Manager's/Product's portfolio that differ from the benchmark index. Where there are gaps in information in the Petajisto or Morningstar dataset 302A, sequential measures of Active Share are smoothed to complete the dataset 302B. In this context, it will be appreciated that the terms “gap” and “gaps,” with respect to information in a particular dataset, generally refer to missing data that are otherwise collected and/or reported periodically. For instance, where Active Share data are generally reported monthly, but data from September are not collected or cannot be accurately reported (e.g., due to natural disaster, insufficient or anomalous trading activity, computer network failures or denial of service attacks, or some other factor), then data for the period including September may be missing or unreliable, creating a gap in an otherwise monthly reporting schedule. In this case, sequential or successive measures of Active Share data on either side of the gap that are actually available may be “smoothed,” such as via interpolation techniques or other smoothing methodologies that are generally known in the art or developed in accordance with known principles. These techniques generally use a respective data point from each side of the gap, or in some instances, multiple data points from each side of the gap. Those of skill in the art will appreciate that there are many suitable approaches to smoothing out data series (e.g., using exponential smoothing, linear interpolation, and the like) that may have utility in the context of the embodiments set forth herein. Accordingly, the present disclosure is not intended to be limited by any particular smoothing or interpolation methodologies intended to account for missing or otherwise unreliable data within a particular periodic dataset.

In the step indicated by the diagram block 303, factor inputs are provided. The factor inputs (i.e., variables) comprise raw factor data for factors and industries extracted from Barra using the FactSet Portfolio tools (SPAR/Portfolio Analytics). Factors from the USE4 Model are used for U.S. equity and the GEM3 Model for global equity. Composite indices for sectors (cyclical, defensive, interest rate sensitive) are generated using Barra industry risk data, mapped to GICS sectors, then combined into a single index using a volatility-weighted approach, described in accordance with the following mapping shown in Tables 1 and 2:

TABLE 1
Internally Developed FactSet Factors vs. Barra Factors

| FACTSET FACTORS | BARRA FACTORS | BARRA FACTORS METHODOLOGY |
|---|---|---|
| Emerging Markets Risk | EM Country Risk | Weighted average of EM country risk |
| | Factor | factors. EM country weighting is extracted |
| | | from FactSet using MSCI Emerging |
| | | Markets Index and country risk factors are |
| | | extracted from Barra GEM3 Model using |
| | | the FactSet Portfolio tools. |
| Big vs. Small | Size Factor | Log of the market capitalization of the firm |
| Long Term Debt to | Leverage Factor | 0.75 * Market Leverage + 0.15 * Debt to |
| Equity | | Asset + 0.1 * Book Leverage |
| Price Momentum | Momentum Factor | The sum of excess log returns over the |
| | | trailing 504 trading days with a lag of 21 |
| | | trading days in order to avoid the effects |
| | | of short-term reversal |
| Price to Book | 1/Book to Price | Last reported book value of common |
| | Factor | equity divided by current market |
| | | capitalization |
| Price to Earnings | 1/Earning Yield | 0.75 * Predicted Earnings to Price Ratio + |
| Price to Cash Flow Ratio | Factor | 0.15 * Cash Earning to Price Ratio + |
| Price to Earnings NTM | | 0.1 * Trailing Earnings to Price Ratio |
| Sales Growth 1 Year | Growth Factor | 0.7 * Long Term Predicted Earnings |
| Earnings Momentum | | Growth + 0.2 * Trailing Five Years |
| EPS_LTG | | Earnings Growth + 0.1 * Trailing Five |
| | | Years Sales Growth |

TABLE 2
Sector Groups

Interest Rate Sensitive (Financials and Consumer Discretionary)
Defensive (Health Care, Consumer Staples, Telecommunications and
Utilities)
Cyclical (Industrials, Materials, Information Technology, Energy (minus
the Oil and Gas sub-industry)
Oil and Gas Sub-Industry

In developing the inputs for the Sector Factors, a volatility weighting approach is used. The intent of this approach is to adjust the weights of sectors dynamically, using a 24-month rolling window, so that no single sector dominates any particular factor. In developing the weights, the variance of returns for a given factor is measured and inversed to yield an inverse variance. This procedure is completed for each of the ten GICS sectors. The measure of inverse variance is then divided by the total variance across sectors associated with a particular factor (e.g., Consumer Discretionary and Financials for Rate Sensitive). The weights are then multiplied and calculated using a look back window of 24 months by the current month returns for the factor. The sum represents the current month input for each factor.

In order to address the potential for multicollinearity, the Oil and Gas sub-industry factor returns are removed from the Energy sector factor derived from volatility-weighted sub-industry factor returns. Remaining sub-industries are related to services and equipment, both of which have less direct correlation with the oil price.

In the step indicated by the diagram block 304, the Portfolio Manager's/Product's excess returns are segmented into overall excess return, factor “clone” excess return, and stock selection excess return, which are expressed in the following equation:

$${ExcessReturn}_{i} = {R}_{i} - M$$

$${R}_{i} = {α}_{i} + {\sum }_{j}^{ } ( {β}_{i , j} \times {F}_{j} )$$

$$M = {α}_{mkt} + {\sum }_{j}^{ } ( {β}_{mkt , j} \times {F}_{j} ) \\ ∴ {ExcessReturn}_{i} = ( {α}_{i} - {α}_{mkt} ) + {\sum }_{j}^{ } [ ( {β}_{i , j} - {β}_{mkt} ) \times {F}_{j} ]$$

wherein:
i=Portfolio Manager/Product number;
j=factor number;
R=Portfolio Manager/Product return;
M=market return;
F=factor return;
α=intercept; and
β=sensitivity with respect to each factor F.

Portfolio Manager/Product excess returns are decomposed into factor clone return Σⱼ[(β_{i,j}−βₘₖₜ)×Fⱼ] and stock selection return (αᵢ−αₘₖₜ) in order to help better understand a Portfolio Manager's/Product's investment style and decide which effect is attributable to Portfolio Manager's/Product's performance. Specifically, it may have utility in some instances to determine overall excess return (i.e., the total return of an index with some benchmark subtracted from it), factor clone excess return, and stock selection excess return independently. In the foregoing manner, it is possible to segment excess returns into constituent components and to analyze the segments showing positive (or negative) performance; segments performing better or worse than corresponding segments in the benchmark may then be identified, and performance attributable to effects of the investment strategy and performance attributable to temporal market events may be disaggregated.

Several analytical inputs are generated in step 306, using skill score measures. Skill scores are measured 305 at the total excess return level, the factor excess return level, and stock selection excess return level. In a preferred embodiment, a rolling window period of 36 months is used. Skill score measure is measured by assessing the ability of Portfolio Managers/Products to outperform the index on a “pass-fail” basis over a period of time. Positive excess return yields a value of 1, while negative excess return yields a value of 0. Thus, this is a binary series of data. In that regard, in the context of the present disclosure, a “skill score” may generally be considered a simple indication of whether some benchmark or threshold return is achieved, rather than a qualitative indicium that seeks to measure the extent of success or failure.

Taking this fact into account, the probability of outperformance given the total number of trials is measured, assuming randomness (i.e., 50% probability of positive excess return and 50% probability of negative excess return). The cumulative probability is then converted to a z-score using an inverse normal distribution. As the total number of trials approaches infinity, the binomial distribution approaches the normal distribution. As a practical matter, the assumption of similarity can benchmark and develop the skill metric.

In developing the skill scoring methodology, therefore, the present system and method attempt to equate Portfolio Manager/Product performance with flipping coins. In this way, the system enables users to assess the likelihood that a Portfolio Manager's/Product's return stream was randomly generated using a z-score. The approach is described further in the example below:

### EXAMPLE 1

1) A Portfolio Manager's/Product's returns versus a relevant benchmark are measured. The series of positive and negative returns are converted to a binary stream, using “1” to identify positive excess returns and “0” to identify negative excess returns.
2) Using this binary stream, the probability of occurrence is determined using the binomial distribution. As noted above, each “1” represents a successful trial; each “0” represents an unsuccessful trial. Therefore, the probability of success is assumed to be 50%, effectively suggesting that Portfolio Manager/Product outperformance is a random occurrence. Using this approach, the cumulative density of the binomial distribution is calculated via, e.g., a server that is configured to provide this functionality. The binomial distribution is suited for the present method because it measures a set of discrete outcomes in a given sample set.
3) As the number of observations approaches infinity, the binomial distribution and normal distribution are approximately equal. While it is noted that the dataset is not likely to actually approach infinity in operation, this is used to generate a score to rank Portfolio Managers/Products given the likelihood of their ability to outperform a benchmark. The cumulative probability for the binomial distribution is then used to calculate the inverse of the standard normal distribution curve.
4) The resultant measure given the above approach is a z-score. The z-score is used as a measure of skill. The further the z-score is from the value of 0, the more likely it is that a Portfolio Manager's/Product's performance stream was generated with skill versus luck. In this regard, a high z-score is desired; and a Portfolio Manager/Product may be selected for inclusion in a portfolio if the z-score is above a predetermined threshold.

For the purposes of segmentation, each Portfolio Manager's/Product's three-year forward rolling excess return is measured for the subsequent 36 months given the present metrics 307. In other embodiments, however, it is contemplated that other periods of time may be used. In this regard, information related to each Portfolio Manager/Product from a short historic window is incorporated.

Using the skill metrics, Active Shares, along with Manager monthly return over time, a cross sectional rolling regression model with rolling window of one month is calibrated using a variety of combinations of inputs to forecast the probability of outperforming different market benchmarks by certain magnitudes over the subsequent 36 month period 308. It is noted that other combinations of inputs may also be used to forecast the probability of Managers outperforming market benchmarks relative to their investment style. As set forth above, such a rolling regression model approach may be useful in determining changing probabilities of outperformance as new data influencing those probabilities become available. In some instances, it may be useful dynamically to change models, for instance, as a result of a comparison of the accuracy of two different models run over the same historical period. Where one model appears to have produced better accuracy over a particular period of time, that model may be employed as a substitute for a less accurate model (e.g., using different variables, a rolling window having a different duration, a different benchmark, or the like).

Cross sectional rolling regression model is used to forecast Portfolio Manager/Product future performance. The following example describes a forecasting model. In this case, the dependent variable being forecasted is the probability of a Portfolio Manager/Product outperforming the market benchmark relative to its investment style over the subsequent three-year period.

### EXAMPLE 2

A dataset 114 (FIG. 1) for a forecasting model may comprise Portfolio Manager/Product historical monthly data for a given period of time, wherein the forecasting model is a combination model comprising a plurality of individual models. In one embodiment, the combination model includes Raw Active Share, Active Share Quartile, and Skill Score (Total, Factor and Stock Selection) models. In one embodiment, the dataset 114 (FIG. 1) may comprise data for x-number of Managers for one period of time. In another embodiment, the dataset 114 (FIG. 1) may comprise data for y-number of Managers for another period of time. The dataset 114 (FIG. 1) may further comprise independent variables and a dependent variable. Independent variables comprise rolling 36-month Skill Score (Total, Excess, Factor, Stock Selection) for each Portfolio Manager/Product and Active Share. The dependent variable comprises forward 36-month excess return and Edge Measure (Total, Excess, Factor, Stock Selection) or forward benchmark relative excess return for the given period of time and edge measures, which measures an advantage in a bet. In particular, to those of skill in the financial forecasting arts, the term “forward benchmark relative excess return” is generally understood to mean forward-looking excess returns relative to a benchmark index, and the term “edge measures” is generally understood to mean edge calculations based on Kelly criterion and that represent an advantage (i.e., an “edge” or “favorable odds”) in connection with a bet or other risky situation.

In one embodiment, cross sectional rolling regression is used to test multiple independent factors, and select the best predictor(s) for the dependent variable. This method is used to generate forecasts 309. To avoid look-ahead bias in the dependent variable, the methodology multiplies regression betas with out-of-sample independent variables to forecast 3-year forward returns.

Accuracies are measured by comparing forecasts with Portfolio Manager/Product true magnitude of benchmark relative excess return or alpha relative to the forecasted magnitude or threshold of benchmark relative excess return for each of the corresponding month or sample time period 310. For example, accuracy is correct if both forecasted and actual performance of the Manager/Product exceeds the relevant market benchmark by 1%. In contrast, forecast is incorrect if the actual performance of the Manager/Product is below the 1% benchmark relative excess return threshold that the Manager/Product was forecasted to achieve.

To determine the efficacy of each of the forecast models, an analysis is performed to determine the overall accuracy and time series of accuracy for each one 311. In addition, combinations of forecasts are assessed to determine whether diversifying a signal 312 makes a material difference in accuracy of forecasting the Portfolio Managers/Products that are expected to outperform the market benchmark relative to their investment style. The forecast models, in isolation, are intended to identify the Portfolio Managers/Products whose performance is likely to exceed the market index (i.e., benchmark) applicable to the Portfolio Manager's investment style, by certain pre-set thresholds 313.

In particular, it will be appreciated that comparing the forecast model with true benchmark relative excess return is generally understood to mean that performance forecasts for a particular Manager over the forecast period may be compared with actual benchmark relative excess return for the same time period. This comparison may be useful as a measure of the success or efficacy of the forecast model; in embodiments employing multiple forecast models, the comparison may be employed subsequently to select a particularly accurate model over another, or as a learning tool to adjust or to fine-tune one or more models for future use. In some instances, a forecast accuracy value may be ascribed or assigned to a forecast model, and respective forecast accuracy values may be compared across different models for the same purpose.

It is therefore submitted that the instant invention has been shown and described in what is considered to be the most practical and preferred embodiments. It is recognized, however, that departures may be made within the scope of the invention and that obvious modifications will occur to a person skilled in the art. Wth respect to the above description then, it is to be realized that the optimum dimensional relationships for the parts of the invention, to include variations in size, materials, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method comprising:
calculating an overall excess return generated by a Portfolio Manager, wherein the overall excess return represents a return on investment in excess of index return data and wherein the index return data are available from a public source;
segmenting the overall excess return by calculating a factor clone excess return and a stock selection excess return, wherein the factor clone excess return represents a contribution of temporal market events and wherein the stock selection excess return represents a contribution of the Portfolio Manager's investment strategy;
calculating a respective skill score associated with each of the overall excess return, the factor clone excess return, and the stock selection excess return; and
generating a forecast model based on the respective skill scores, whereby the forecast model disaggregates effects of the investment strategy and the temporal market events, and wherein the forecast model represents the Portfolio Manager's probability of exceeding a market benchmark rate of return.

2. The method of claim 1 further comprising:
identifying Active Share data for a financial product, wherein the Active Share data are available from a public source; and
wherein said generating a forecast model comprises utilizing a cross sectional rolling regression model comprising the respective skill scores, the Active Share data, and a monthly overall excess return computed for the Portfolio Manager over a period of time, wherein the respective skill scores are converted to a z-score using an inverse normal distribution such that the z-score is directly proportional to the investment strategy rather than the temporal market events.

3. The method of claim 1 wherein the overall excess return is calculated against a stock market index.

4. The method of claim 2 further comprising, when a gap in the Active Share data is identified, smoothing sequential measures of the Active Share data using a respective data point from each side of the gap.

5. The method of claim 2 wherein the respective skill scores are derived from historical monthly data for a given period of time, and wherein the overall excess return includes factors associated with forward benchmark relative excess return for the given period of time and edge measures.

6. The method of claim 1 further comprising comparing the forecast model with true benchmark relative excess return.

7. The method of claim 6 further comprising:
assigning a forecast accuracy value to the forecast model wherein the forecast accuracy value is computed using the true benchmark relative excess return; and
comparing the forecast accuracy value with a different forecast accuracy value assigned to a different forecast model generated based upon a different market benchmark rate of return.

8. A method comprising:
generating a first forecast model to predict a Portfolio Manager's first probability of exceeding a first market benchmark rate of return, the first probability based on a first overall excess return comprising a first investment strategy component and a temporal market events component, whereby the first forecast model disaggregates effects of the first investment strategy component and the temporal market events component;
generating a second forecast model to predict the Portfolio Manager's second probability of exceeding a second market benchmark rate of return, the second probability based on a second overall excess return comprising a second investment strategy component and the temporal market events component, whereby the second forecast model disaggregates effects of the second investment strategy component and the temporal market events component; and
assigning a first forecast accuracy value and a second forecast accuracy value to the first forecast model and the second forecast model, respectively, and comparing the first investment strategy to the second investment strategy responsive to said assigning.

9. The method of claim 8 wherein said assigning comprises computing the first forecast accuracy value and the second forecast accuracy value using a first true benchmark relative excess return and a second true benchmark relative return, respectively.
